(19) United States
(12) Patent Application Publication
(10) Pub. No.: US 2007/0124375 A1
(43) Pub. Date: May 31, 2007

(54) Method and apparatus for defining relationships between collaboration entities in a collaboration environment

(75) Inventors: Ramesh Vasudevan, Nashua, NH (US); Jeremy J. Blanchard, Amherst, NH (US); Neil D. Evans, North Chelmsford, MA (US)

Correspondence Address: CHAPIN & HUANG, L.L.C., Westborough Office Park, 1700 West Park Drive, Westborough, MA, 01581, US

(73) Assignee: ORACLE INTERNATIONAL CORPORATION, REDWOOD SHORES, CA (US)

(21) Appl. No.: 11/291,381

(22) Filed: Nov. 30, 2005

(51) Int. Cl. G06F 15/16

(52) U.S. Cl. 709/204

(57) ABSTRACT

In a software environment for team collaboration, a relationship processor defines relationships between collaboration entities (artifacts) in the collaboration environment. The relationship processor is operable to define, capture, and traverse relationships in a generic manner independently of the underlying types of artifacts included in the relationships. Accordingly, participant artifacts of such a relationship may be a set of workspace artifacts of dissimilar types, and may be associated by a 1:1, a 1:N, or an N:M relation. Therefore, relationships may include individual or sets of artifacts of various cardinality and directionality, as discussed further above. A relationship processor captures the defined relationships in a set of DB tables. The tables enumerate the related entities of the various types instantiated by the applications operative in the workspace. In this manner, the workspace employs a variety of type-unrestricted artifacts for further processing and/or organization.

### BACKGROUND

In a modem information processing environment, a group of users often work together toward a common goal in a collaboration environment. A typical scenario occurs in an employment context between employees in a project group, for example. A project group often delegates tasks to individual members, and then reviews and aggregates the results that individual members produce into an integrated group product, document, application, or other aggregate output or work product. Therefore, the project group often operates as a collaboration group, such that the collective efforts of the group may be aggregated into a whole as a finished product of the collaboration group.

The individual contributions by group members may be in a variety of forms, such as documents, code, figures, charts, memos, notes, and designs, for example. Often these contributions are electronically generated and modified by a variety of software applications, such as word processors, compilers, graphical tools, email, calendar tools, schedulers and the like, and are stored as a particular type of file, document or other data. Managing and coordinating the different contributions from the collaboration group members (users) typically involves ensuring that changes and additions made by each user are accessible to other users and not overwritten by other users. Accordingly, a conventional collaboration group work environment often employs a number of administrative tools and aids for providing operations such as configuration management, revision libraries, concurrency controls, and version tracking, to name several, for ensuring preservation of the collective group effort.

### SUMMARY

A collaboration environment facilitates the aggregation of individual efforts toward a common group goal. Such a collaboration environment serves to retain and consolidate individual contributions for usage toward the group effort, and manages administrative functions so as to allow group access to the work product, while also handling concurrency issues which may result in redundant or mitigation of group efforts, such as accidental overwrites and duplicate updates. A typically collaboration environment exists in an employment context, where employee groups work toward a common product, release, document, design or subsystem, for example. Collaboration software supporting the collaboration environment coordinates access and storage of the files and objects that are representative of the group work product.

Embodiments disclosed herein operate in a software based collaboration environment. In such an environment, a collaboration group of users coordinates and aggregates efforts through a common collaborative workspace via collaborative access to a set of independently operable software applications such as an email application, a file system application, a calendar application, a threaded discussion forum, or other applications that are selectable for inclusion into the collaborative workspace. The collaboration workspace includes collaboration entities, or artifacts, which are objects that may be manipulated within the workspace. Such artifacts include, for example, files, users, applications, email messages, tasks, schedules, calendar entries, and other objects generated, processed, or displayed by or in conjunction with the workspace. In general, the collaborative workspace allows users to access the set of independently operable software applications, and coordinates contributions of individual users such that the common collaborative workspace effectively aggregates the collective effort of the collaboration group.

Collaborative workspaces (CW) are online facilities that allow a group of people (users, employees, etc.) to work toward some common objective. Group work activities are almost always bound by a specific timeframe (when should be done) and deliverables (what is going to be delivered). From the understanding of the end deliverable and time allocated, tasks are assigned. These group work activities may be ad-hoc (e.g. plan for a group move) or a regular part of doing business (e.g. developing a new version of a product) or even ongoing activities (e.g. establishing and monitoring for best practices). These activities often require coordination among the team members and an efficient organization scheme for tracking all of the content that is shared and produced.

A collaborative workspace tracks all the artifacts that are shared and produced as a result of the activities performed by the team members in achieving project goals. These artifacts can be of various types such as documents, email messages, threaded discussions, meetings (physical and online web conferences), shared contact lists, conversations (instant messages, recorded phone conversations, etc), tasks, links, lists (issues trackers, announcements, FAQs, etc), surveys, polls, etc.

Configurations of the invention are based, in part, on the observation that, in a collaboration environment, artifacts typically have an association to other artifacts. These associations are expressible as relationships between the various artifacts (collaboration entities, or objects) included in the workspace. Gathering and identifying these relationships facilitates many aspects of workspace processing, such as reporting, updating, and querying the workspace artifacts. For example, a user may wish to identify all meetings created by a supervisor, or identify all documents pertaining to a particular meeting. Artifact relationships as provided by configurations herein are employable to identify such related artifacts.

Unfortunately, conventional mechanisms for identifying and defining artifact relationships in a collaboration environment suffer from several shortcomings. Conventional collaboration software focuses on point solutions wherein support is provided to relate specific kinds of artifacts to other specific artifact types. For example, conventional approaches may provide the ability to discuss a document via email, thus correlating documents with a string of email messages. Such conventional approaches tend to be bounded by the artifact types included in a relationship. Conventional approaches do not provide a collaboration framework that provides a generic model for defining, capturing and traversing relationship networks between artifacts

Accordingly, configurations herein substantially overcome the above described shortcomings by defining relationships between collaboration entities (artifacts) in a collaboration environment operable to define, capture, and traverse relationships in a generic manner independently of the underlying types of artifacts included in the relationships. Accordingly, participant artifacts of such a relationship may be a set of workspace artifacts of dissimilar types, and may be associated by a 1:1, a 1:N, or an N:M relation. Therefore, relationships may include individual or sets of artifacts of various cardinality and directionality, as discussed further below. A relationship processor captures the defined relationships in a set of tables. The tables enumerate the related entities of the various types instantiated by the applications operative in the workspace. In this manner, the workspace employs a variety of type-unrestricted artifacts for further processing and/or organization. The resulting relationship tables therefore codify the artifacts according to workspace genre, rather than a somewhat less user intuitive arrangement such as the instantiating application, file type, and user/owner, which is typical in conventional collaboration environments.

In further detail, the method for defining relationships between collaborative entities in a collaborative environment as disclosed by configurations herein includes identifying an association between a plurality of workspace artifacts in a collaborative workspace, such that the association is indicative of a commonality between the workspace entities. A relationship processor defines a relationship between the identified plurality of workspace artifacts, in which the workspace artifacts each having an entity type and a common relationship type corresponding to the identified association. A collaboration storage repository captures the relationship between the workspace entities, capturing denoting the workspace artifacts as participant entities in the defined relationship corresponding to the workspace. In the exemplary configuration, the relationship processor is operable to identify the commonality between workspace entities of different types. Therefore, each of the participant workspace artifacts is a heterogeneous set of entities, in which the artifacts include workspaces and included entities (artifacts) within the workspace. The workspace is further inclusive of at least one of applications, users, emails, documents, meetings, tasks and reminders.

Further, defining the corresponding relationship includes identifying dynamic relationships operable to identify relationship participants based on a predetermined selection criteria applicable to the plurality of artifacts. The predetermined selection criteria comprises selective query identification operable to conditionally identify entities for inclusion in a relationship, such as via a SQL query. Identifying the dynamic relationships may include employing implicit logic operable to identify at least one of documents, meetings, tasks, reminders, email attachments and meeting attendees included in the workspace. Implicit logic is indicative of related entities, such that the implicit logic identifies contexts in a workspace indicative of a definable relation between a plurality of entities, such as a common project, supervisor, meeting, or other common theme.

The relationship processor defines the relationship by identifying a type of the relationship, the identity of each participant entity in the relationship, and the type of each participant entity. The relationship processor further determines the cardinality of the relationship based on the plurality of associated workspace artifacts, such that cardinality indicative of one-to-one, one-to-many or many-to-many.

The relationship processor employs the collaboration storage repository to define the relationship in a relationship table, such that the relationship table indicative of the type of relationship and cardinality of the relationship. The collaboration storage repository captures relationships by storing, for each participant in the relationships, an entry in a relationship artifact table indicative of each artifact and relationship to which it belongs. The resulting captured relationships are subsequently employed by a browser or other graphical application for traversing the defined relationships by matching identified relationships with each of the participants of that relationship, and visualizing, on a graphical display, a representation of each of the workspace artifacts for observation by a user.

Alternate configurations of the invention include a multiprogramming or multiprocessing computerized device such as a workstation, handheld or laptop computer, cellphones or PDA device, or dedicated computing device or the like, configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a computer-readable medium including computer program logic encoded thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM or RAM or PROM chips, field programmable gate arrays (FPGAs) or as an Application Specific Integrated Circuit (ASIC). The software or firmware or other such configurations can be installed onto the computerized device (e.g., during operating system for execution environment installation) to cause the computerized device to perform the techniques explained herein as embodiments of the invention.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of an exemplary collaboration environment suitable for use with configurations discussed herein;

FIG. 2 is a flowchart of relationship definition in the collaboration environment of FIG. 1;

FIG. 3 is a block diagram of artifacts (collaboration entities), relationships and corresponding database tables in the environment of FIG. 1; and

FIGS. 4-6 are an exemplary sequence of relationship usage in the system of FIG. 3.

### DETAILED DESCRIPTION

In a software environment for team collaboration, users collaborate using a workspace having collaboration entities. Configurations herein define relationships between collaboration entities (artifacts) in such a collaboration environment, and define, capture, and traverse relationships in a generic manner independently of the underlying types of artifacts included in the relationships. Accordingly, participant artifacts of such a relationship may be a set of workspace artifacts of dissimilar types, and may be associated by a 1:1, a 1:N, or an N:M relation. Therefore, relationships may include individual or sets of artifacts of various cardinality and directionality, as discussed further below. A relationship processor captures the defined relationships in a set of DB tables. The tables enumerate the related entities of the various types instantiated by the applications operative in the workspace. In this manner, the workspace employs a variety of type-unrestricted artifacts for further processing and/or organization. The resulting relationship tables therefore codify the artifacts according to workspace genre, rather than a somewhat less user intuitive arrangement such as the instantiating application, file type, and user/owner, which is typical in conventional collaboration environments

By way of further background, the collaborative workspace referred to herein is employable for a variety of group efforts, using any of a plurality of available applications, for endeavors such as software development, document preparation and maintenance, design specifications, knowledge bases, and other collaborative undertakings in which a group of users focus their collective expertise on a solution or product. Further details and discussion on a collaboration workspace suitable for use with the configurations disclosed herein are disclosed in co-pending U.S. patent application No. 11/___,___ filed November __, 2005, entitled “METHODS AND APPARATUS PROVIDING COLLABORATIVE ACCESS TO APPLICATIONS” (Atty. Docket No. OID05-01(01201), the entire contents and teachings of which are hereby incorporated herein by reference in their entirety.

In typical collaboration environments, the artifacts produced and shared in a collaborative workspace are related to each other. For instance, consider a workspace created to respond to a sales Request For Proposal (RFP). As part of responding to the sales RFP, the team members create an initial draft of a proposal document. The team members conduct online threaded discussions to resolve outstanding issues in sections of the document. When the online discussions fail to completely resolve all issues, the team members schedule a calendar meeting to resolve the outstanding issues. As a result of the calendar meeting, certain tasks are created and assigned to some of the team members to investigate and bring all outstanding issues to a final resolution. In this above example, all the artifacts produced, such as the proposal document, the threaded discussion to resolve outstanding issues, the calendar meeting scheduled to continue the online threaded discussion and the tasks that resulted from the calendar meeting, are related to each other by the common goal of generating the sales RFP proposal document. The relationships between the different kinds of artifacts are captured in a persistent manner by configurations discussed herein, and are made available as an attribute of any of the artifacts being examined, such as via a GUI tool for traversing the workspace.

Configurations discussed below provide support for relationship network management in an online collaborative facility. Such support defines a model for defining, capturing, and traversing relationship networks between artifacts of different types in the online collaborative facility and provides a reference implementation of the same. In contrast, conventional approaches in this space have focused on point solutions wherein support is provided to relate specific kinds of artifacts to other artifacts. For example, typical conventional solutions may provide the ability to discuss a document via a series of emails. Conventional approaches do not define collaboration frameworks that provide a generic model for defining, capturing and traversing relationship networks between artifacts as disclosed herein.

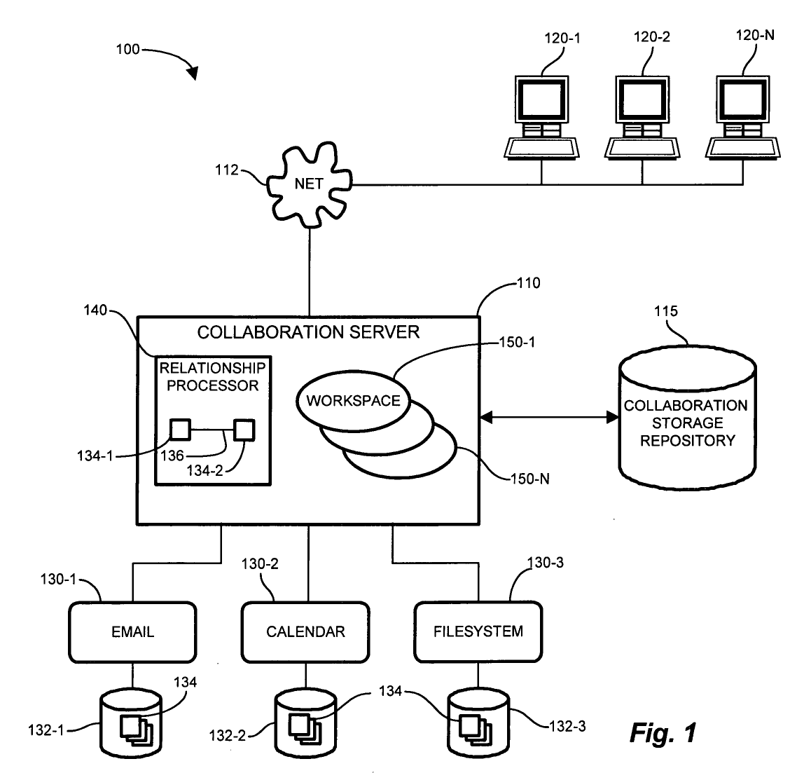

FIG. 1 is a context diagram of an exemplary collaboration environment 100 suitable for use with configurations discussed herein. Referring to FIG. 1, the collaboration environment 100 includes a collaboration server 110 having a relationship processor 140 and a plurality of users 120-1 . . . 120-N (120 generally) interconnected via a network 112 such as the Internet, VPN, LAN, WAN or other packet switched interconnection medium. The collaboration server 110 includes one or more workspaces 150-1 . . . 150-N (150, generally) for providing collaborative access to a plurality of applications 130-1 . . . 130-3 (130 generally). The applications 130, therefore, provide services to the users 120 via the workspace 150 and the network 112. Each of the applications 130 generates or instantiates artifacts 134 as part of the ongoing services provided by the application. Each of the applications 130 has respective storage area repositories 132-1 . . . 132-3 (132 generally) for maintaining the artifacts 134 as application 130 objects. It should be noted, therefore, that the artifacts 134, as employed herein, refers to any objects which may be generated or instantiated by the applications 130, and are employed within the workspace 150 as collaboration entities, meaning that they are accessible to the users 120, applications 130, and other entities included within the workspace that defines the collaboration group. These artifacts 134-1, 134-2 (134 generally) are operable as collaboration entities in the workspace 150, collectively with the artifacts 134 generated by other applications 130, and are adapted to have relationships 136 with other artifacts 134 (collaboration entities) as identified and defined by the relationship processor 140.

The workspaces 150, therefore, are operable to store and manipulate the artifacts 134 containing application data generated by the applications 130. Each of the workspaces 150 defines a particular collaboration environment, including the users 120, applications 130, and other metadata that defines the data and objects included in the workspace on behalf of the collaboration group. The server 110 also connects to a local collaboration storage repository 115, which is operable to store the workspace 150 as a template on a disk volume or other form of local collaboration storage 115. Further details on storage and retrieval of workspaces as templates may be found in copending U.S. patent application No. 11/___,___, filed Oct. __, 2005, entitled: “METHODS AND APPARATUS FOR DEFINING A COLLABORATIVE WORKSPACE” (Atty. Docket No. OID05-02(01301)).

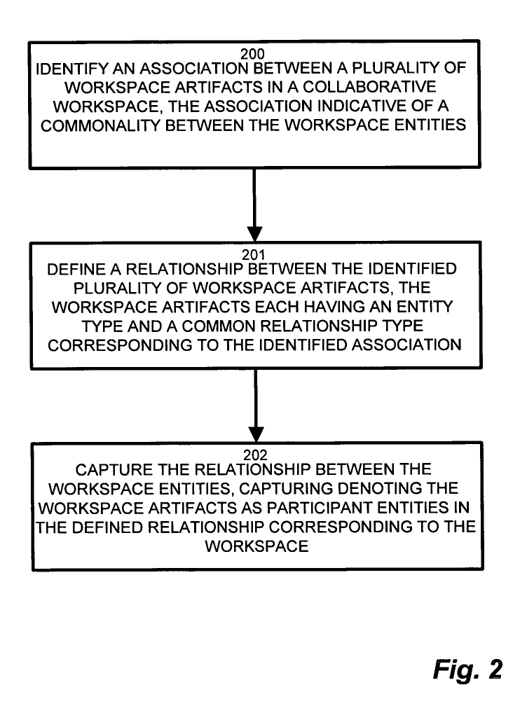

FIG. 2 is a flowchart of relationship definition in the collaboration environment of FIG. 1. Referring to FIGS. 1 and 2, the method for defining relationships 136 between collaborative entities in a collaborative environment includes, at step 200, identifying an association between a plurality of workspace artifacts in a collaborative workspace, such that the association is indicative of a commonality between the workspace entities. Such a commonality may be, for example, a particular meeting, author, or product to which each of the workspace entities 134 pertains. The identified associations may be between artifacts of different types, such as emails, documents, and calendar entries, therefore collectively grouping dissimilar entities in the workspace based on a common attribute, property or context.

At step 201, the relationship processor 140 defines a relationship 136 between the identified plurality of workspace artifacts, such that the workspace artifacts each having an entity type and a common relationship 136 type corresponding to the identified association. The relationship 136 type denotes the nature of the commonality between the entities (artifacts) 134, such as a common author (i.e. all mail messages from a supervisor), a common meeting, such as all calendar entries about a particular meeting, or a common document (i.e. all emails about a particular design specification), for example.

At step 202, the relationship processor 140 employs the workspace repository 115 to capture the relationship 136 between the workspace entities 134-1, 134-2, such that capturing denotes the workspace artifacts 134 as participant entities in the defined relationship 136 corresponding to the workspace 150. As will be explained further below, in particular configurations, the relationship processor 140 captures the relationships in a relationship database in the collaboration storage repository 115. The relationship database has at least four tables, including tables for relationships, participant artifacts, relationship types, and inverse relationships.

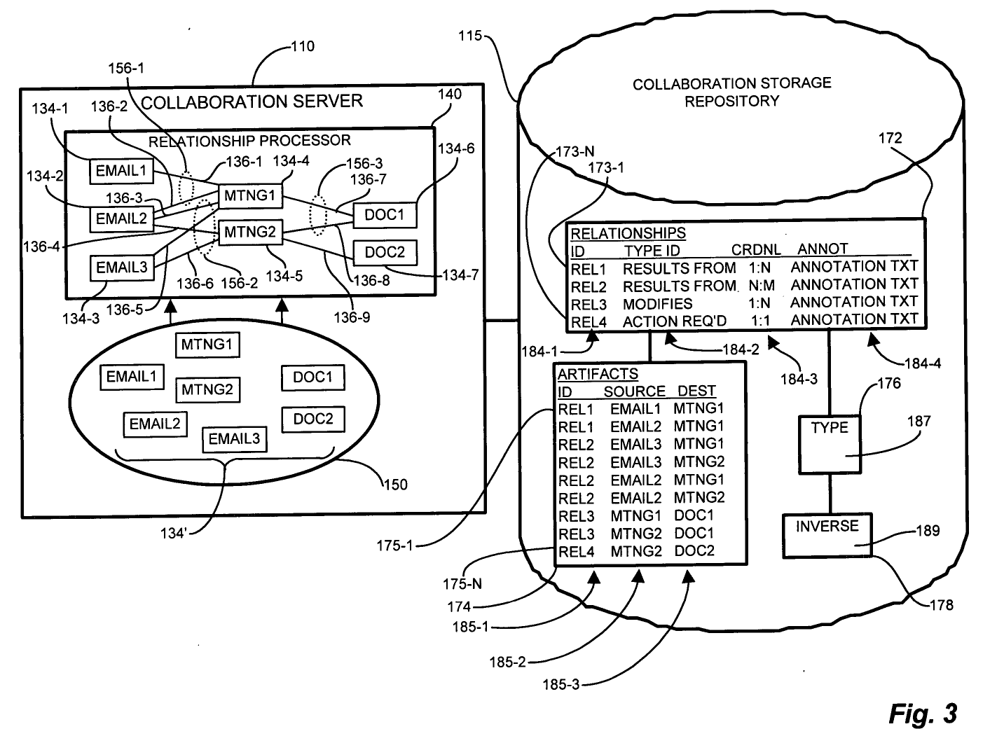

FIG. 3 is a block diagram of artifacts (collaboration entities) 134, relationships 136 and corresponding database tables in the environment of FIG. 1. Referring to FIG. 3, the collaboration server 110 includes the relationship processor 140 for identifying and defining relationships 136 between the artifacts 134. The relationship processor 140 identifies the artifacts 134 in the workspace 150 and defines the relationships 136-1 . . . 136-9 (136 generally) between the artifacts 134. In contrast with previous approaches, conventional collaboration environments may not denote relationships between objects corresponding to different applications 130, and therefore simply maintain a set of distinct application objects. The collaboration server 110 couples to the collaboration storage repository 115, which includes tables indicative of the defined relationships 136. The tables include a relationship table 172, indicating the type and cardinality of each relationship 136, and an artifact table 174, indicating the member artifacts 134 of each relationship 136. Each relationship 136 also has a type description, shown in table 176, and certain types of relationships have inverse relationships 136, shown in table 178. Further, the relationships may be annotated, similar to the type description label, to provide a mechanism to capture user-meaningful metadata about a particular relationship. The annotations may aid the user in qualifying the relationship object itself so as to correlate information such as reasons for relating the artifacts, for example.

Relationships also have a cardinality of 1:1, 1:N or N:M, indicating the member artifacts 134 of the relationship 136, and a directionality, such that an inverse relationship 136 also exists. The cardinality is illustrated by the dotted lines 156-1 . . . 156-3, encompassing the member artifacts 134 included in a 1:N or N:M relationship. The relationship table 172 includes entries 173-1 . . . 173-N (173 generally) for each defined relationship. Each entry 173 includes a relationship 184-1, a type 184-2, a cardinality 184-3 and an annotation 184-4. The artifact table 174 includes at least one entry 175-1 . . . 175-N for each relation, and identifies the member artifacts 185-2 and 185-3, denoted as source and destination, for each relation identifier 185-1. The type table 176 includes a type description 187 for each relationship type 184-2, and may also list an inverse entry 189 in the inverse table 178, for relations which have an inverse. Inverse relations may be employed, for example, in the case of a 1:N relation, such as emails based on a single meeting (a “based on” or “results from” relationship) to define an “effects” inverse relation from the email back to the meeting, thus identifying the deterministic member of the relationship 136. In the case of such an inverse relation, the directionality between the member artifacts 185-1,185-2 becomes significant.

In operation, the artifact set 134′ is accessible in the workspace 150 through the individual applications 130 which instantiated them. The relationship processor 140 identifies the relationships 136-1 . . . 136-9 through identified associations, or commonalities, between the artifacts 134-1 . . . 134-7 in the workspace 150. The exemplary relationships include a 1:N relationship between EMAIL 1, EMAIL 2, and MTNG1 156-1, shown by relationship REL1 in the relationship table 172 and captured as entries 175-1 and 175-2 in the artifact table 174. Another 1:N relationship 156-3 exists as REL4 in the relationship table 172 between MTNG1, MTNG2 and DOC1, captured as entries 175-7 and 175-8 in the artifact table 174. Further, a N:M relationship 156-2 is shown as REL2, between EMAIL2, EMAIL3, MTNG1 and MTNG2, captured as artifact entries 175-3 . . . 175-6 in the table 174.

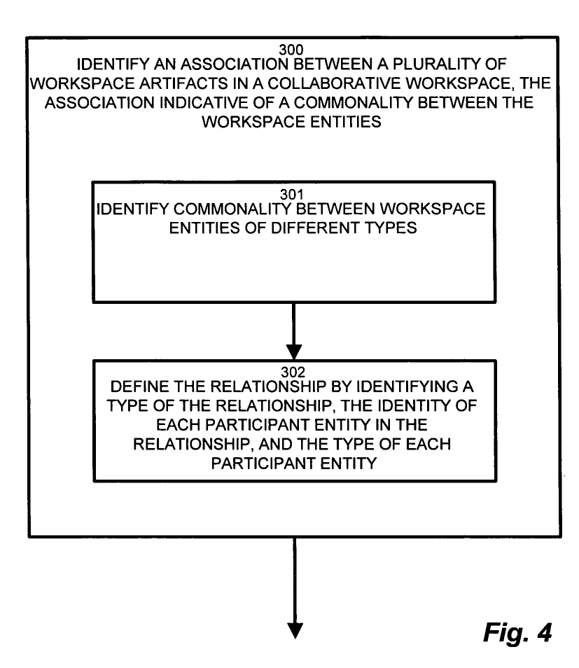

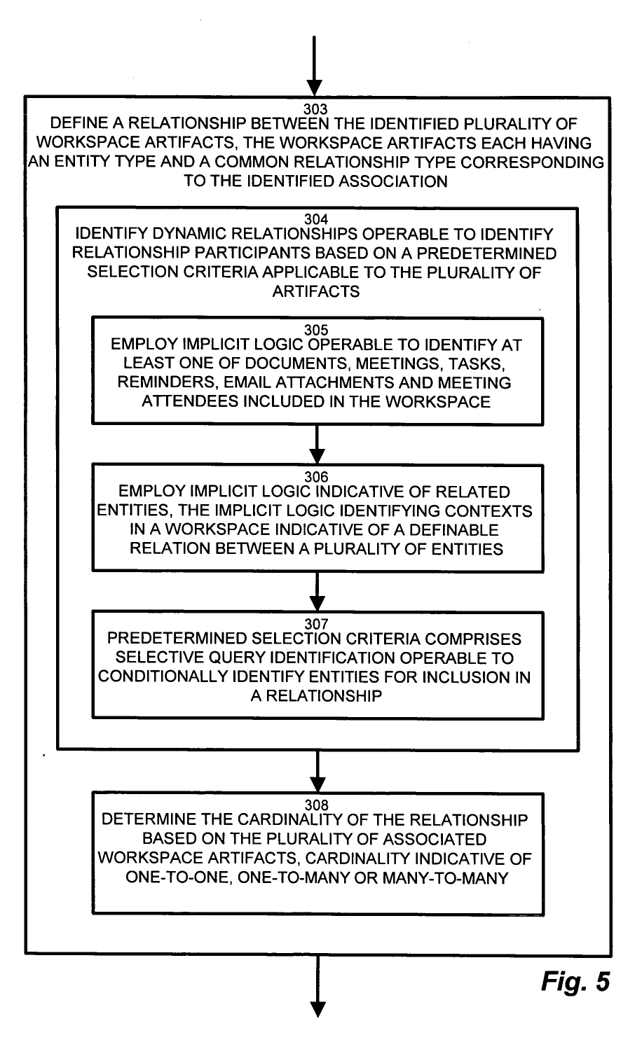

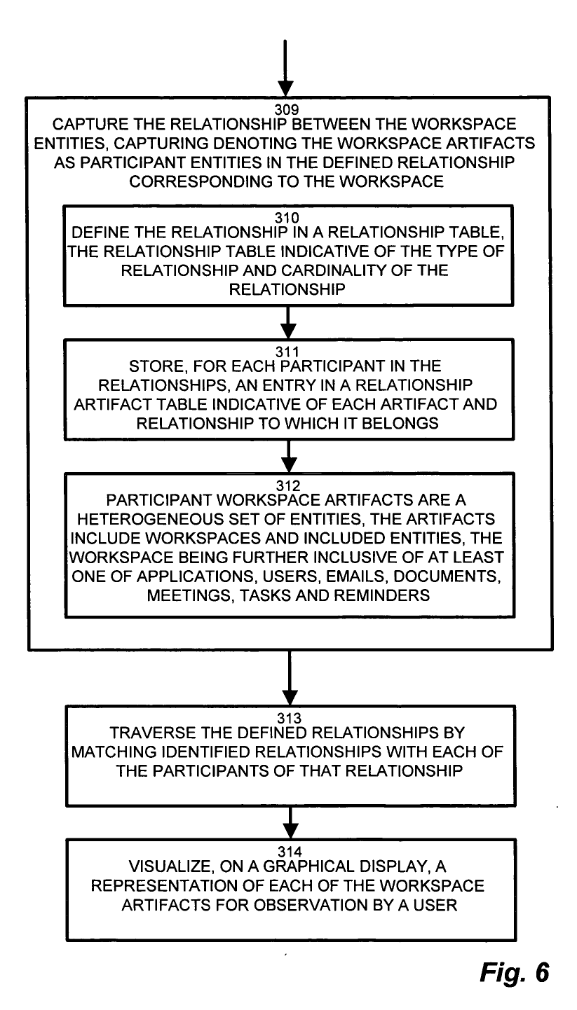

FIGS. 4-6 are an exemplary sequence of relationship usage in the system of FIG. 3. Referring to FIGS. 3-6, in further detail, defining the relationships 136 between collaborative entities includes, at step 300, identifying an association between a plurality of workspace artifacts 134 in a collaborative workspace 150, in which the association is indicative of a commonality between the artifacts (workspace entities) 134. The association is typically a common attribute, such as an author, topic, project, or other associative fact derived from the context between the participant workspace entities. Therefore, in the exemplary configuration, identifying the associations includes identifying the commonality between workspace entities of different types, as depicted at step 301. The associative fact may also identify a type of the relationship, the identity of each participant entity in the relationship, and or the type of each participant entity, as depicted at step 302.

Having identified the associating between a plurality of workspace artifacts 134 (entities), at step 303 the relationship processor defines a relationship 136 between the identified plurality of workspace artifacts, in which the workspace artifacts each have an entity type and a common relationship type corresponding to the identified association. Defining the relationship codifies the identified association in a processable form operable to be processed and stored according to configurations of the invention. The defined relationships are then operable to be stored in the collaboration storage repository 115 and manipulated by the collaboration server 140 as relationships 136 between the artifacts 134. Typically the defined relationships 156 are manipulated by application code of the applications 130 (FIG. 1) for performing various tasks, operations and/or functions on behalf of users 120 of the workspace 150.

The relationships may be static or dynamic. A static relationship is one where the set of artifacts participating in the relationship are explicitly listed. A dynamic relationship is one where the set of objects (e.g. artifacts 134) participating in a relationship 136 are determined dynamically at runtime. Therefore, the set of objects in a dynamic relationship 136 may defined using a query that, when executed, identifies the set of objects to be included in the relationship. Dynamic relationships 136 change over time, and may include, for example the set of artifacts 134 which have changed since a previous login. Such a relationship 136 is determinable by identifying the last login time of the user 120, and comparing modification dates of the workspace artifacts 134. Accordingly the collaboration server 140 defines the relationship 136 by identifying dynamic relationships operable to identify relationship participants based on a predetermined selection criteria applicable to the plurality of artifacts 134, as shown at step 304.

Dynamic relationships often employ implicit logic rather than explicit comparisons (logic) that define static relationships. Identifying the dynamic relationships may include, at step 306, employing implicit logic to identify artifacts 134 such as documents, meetings, tasks, reminders, email attachments and meeting attendees included in the workspace 150. The implicit logic is therefore indicative of related entities, such that the implicit logic identifies contexts in a workspace 150 indicative of a definable relation between a plurality of entities, as depicted at step 306. As indicated above, the logic to identify relationships employs predetermined selection criteria including selective query identification operable to conditionally identify entities for inclusion in a relationship 136, as disclosed at step 307. Therefore, a user 120 often defines relationships 136 using a query expression applicable to the candidate artifacts 134 in the workspace 150.

The relationship processor 140 determines the cardinality 184-3 of the relationship 136 based on the plurality of associated workspace artifacts, cardinality indicative of one-to-one, one-to-many or many-to-many, as depicted at step 308. A particular artifact 134 may be related to many other artifacts 134, characterizing a 1:N (one-to-many) relationship, such as a set of emails authored by a particular user 120. Artifacts 134 may have a many to many relationship 136, such as users authoring documents pertaining to a particular artifact 134 or workspace 150 object. Further, relationships 136 may be 1:1 (one-to-one), and may have a directionality (onto). The directionality also denotes an inverse relation, which may take the form of a parent-child relationship.

The relationship processor 140 captures the defined relationship 136 between the workspace 150 entities in the collaboration storage repository 115, in which capturing denotes the workspace artifacts 134 as participant entities in the defined relationship 136 corresponding to the workspace 150, as depicted at step 309. The storage repository 115 defines the relationship 136 in the relationship table 172, such that the relationship table 172 is indicative of the type 184-2 of relationship and cardinality 184-3 of the relationship 136, as disclosed at step 310. The cardinality 184-3 indicates the multiplicity of artifacts participating (i.e. a member of) a relationship. Cardinality may be dependent on the type of relationship 136, as indicated in table 176, such as a peer or hierarchical relationship. For example, a “results from” relation may indicate participants such as documents and emails created in response to a particular meeting. Relationships 136 may also indicate artifacts 134 which modify another artifact 134, such as a change notice or update to a document or code file. Additionally, artifacts which evoke a further action or response, such as an email mandate or request for a report, may include artifacts to which the action applies. Further, capturing includes storing, for each participant in the relationships, an entry in a relationship artifact table 174 indicative of each artifact and relationship to which it belongs, as shown at step 311.

In the exemplary configuration shown, at step 312, each of the participant workspace artifacts 134 is a heterogeneous set of entities, such that the artifacts 134 include workspaces and included entities, and in which the workspace is further inclusive of at least one of applications 130, users 120, emails, documents, meetings, tasks and reminders. Thus, the collaboration entities (artifacts 134) between which the relationships 136 are defined are not bounded by the particular types of the participant artifacts 134. Accordingly, artifacts of dissimilar types may have relationships.

The captured relationships 136 are beneficial for displaying or reporting sets of artifacts 134 (collaboration entities) having relationship ties to other entities. Traversal of the relationship-bound artifacts 134 yields an artifact matrix or tree illustrating the collection of relationships 136 defined in a particular workspace, along with the types and nature of the participant artifacts 136. The relationship processor 140 traverses the defined relationships 136 by matching identified relationships with each of the participants of that relationship via the tables 172, 174, 176, 178 capturing the relationship 136, as depicted at step 313. The traversed relationships 136 enables the relationship processor to extract and renders a corresponding visual display. Accordingly, the relationship processor 140 allows a user or operator to visualize, on a graphical display, a representation of each of the workspace artifacts for observation by a user, as shown at step 314.

Those skilled in the art should readily appreciate that the programs and methods for defining and capturing relationships in a collaboration environment as defined herein are deliverable to a processing device in many forms, including but not limited to a) information permanently stored on non-writeable storage media such as ROM devices, b) information alterably stored on writeable storage media such as floppy disks, magnetic tapes, CDs, RAM devices, and other magnetic and optical media, or c) information conveyed to a computer through communication media, for example using baseband signaling or broadband signaling techniques, as in an electronic network such as the Internet or telephone modem lines. The operations and methods may be implemented in a software executable object or as a set of instructions embedded in a carrier wave. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and method for defining and capturing relationships in a collaboration environment as defined herein has been particularly shown and described with references to embodiments thereof, it will be understood by those skilled in the art that various changes in form and details may be made therein without departing from the scope of the invention encompassed by the appended claims.

What is claimed is:

1. A method for defining relationships between collaborative entities in a collaborative environment comprising:
identifying an association between a plurality of workspace artifacts in a collaborative workspace, the association indicative of a commonality between the workspace artifacts;
defining a relationship between the identified plurality of workspace artifacts, the workspace artifacts each having an entity type and a common relationship type corresponding to the identified association; and
capturing the relationship between the workspace artifacts, capturing denoting the workspace artifacts as participant entities in the defined relationship corresponding to the workspace.

2. The method of claim 1 wherein identifying further comprises identifying the commonality between workspace artifacts of different types.

3. The method of claim 2 wherein defining the relationship comprises identifying dynamic relationships operable to identify relationship participants based on a predetermined selection criteria applicable to the plurality of artifacts.

4. The method of claim 3 wherein employing predetermined selection criteria comprises selective query identification operable to conditionally identify artifacts as participant entities for inclusion in a relationship.

5. The method of claim 4 further comprising defining the relationship by identifying a type of the relationship, the identity of each participant entity in the relationship, and the type of each participant entity.

6. The method of claim 5 further comprising determining the cardinality of the relationship based on the plurality of associated workspace artifacts, cardinality indicative of one-to-one, one-to-many or many-to-many.

7. The method of claim 6 wherein the identifying the dynamic relationships includes employing implicit logic operable to identify at least one of documents, meetings, tasks, reminders, email attachments and meeting attendees included in the workspace.

8. The method of claim 1 further comprising employing implicit logic indicative of related entities, the implicit logic identifying contexts in a workspace indicative of a definable relation between a plurality of entities.

9. The method of claim 8 further comprising defining the relationship in a relationship table, the relationship table indicative of the type of relationship and cardinality of the relationship.

10. The method of claim 9 wherein capturing includes storing, for each participant in the relationships, an entry in a relationship artifact table indicative of each artifact and relationship to which it belongs.

11. The method of claim 10 wherein each of the participant workspace artifacts is a heterogeneous set of entities, the artifacts include workspaces and included entities, the workspace being further inclusive of at least one of applications, users, emails, documents, meetings, tasks and reminders.

12. The method of claim 11 further comprising:
traversing the defined relationships by matching identified relationships with each of the participants of that relationship; and
visualizing, on a graphical display, a representation of each of the workspace artifacts for observation by a user.

13. A collaboration server for defining relationships between collaborative entities in a collaborative environment comprising:
at least one collaborative workspace having a plurality of workspace artifacts, each of the workspace artifacts operable to have an association to another of the plurality of workspace artifacts in the collaborative workspace, the association indicative of a commonality between the workspace artifacts;
a relationship processor operable to define a relationship between the identified plurality of workspace artifacts, the workspace artifacts each having an entity type and a common relationship type corresponding to the identified association; and
a collaboration storage repository operable to capture the relationship between the workspace artifacts, capturing denoting the workspace artifacts as participant entities in the defined relationship corresponding to the workspace.

14. The server of claim 13 wherein the relationship processor is operable to define the relationship between workspace artifacts of different types.

15. The server of claim 14 wherein the relationship processor is further operable to identify dynamic relationships operable to identify relationship participants based on a predetermined selection criteria applicable to the plurality of artifacts.

16. The server of claim 15 wherein the relationship processor is operable to employ the predetermined selection criteria via selective query identification operable to conditionally identify collaboration entities for inclusion in a relationship.

17. The server of claim 16 wherein the relationship processor is operable to define the relationship by identifying a type of the relationship, the identity of each participant collaboration entity in the relationship, an annotation defining the reason for the relationship and the type of each participant collaboration entity.

18. The server of claim 17 wherein the relationship processor is further operable to identify dynamic relationships by employing implicit logic operable to identify at least one of documents, meetings, tasks, reminders, email attachments and meeting attendees included in the workspace.

19. The server of claim 18 wherein the implicit logic is indicative of related entities, the implicit logic identifying contexts in a workspace indicative of a definable relation between a plurality of collaboration entities.

20. The server of claim 19 wherein the collaboration storage repository further comprises a relationship table, the relationship table indicative of the type of relationship and cardinality of the relationship.

21. The server of claim 20 wherein the collaboration storage repository further comprises a relationship artifact table operable to store, for each participant in the relationships, an entry in the relationship artifact table indicative of each artifact and relationship to which it belongs.

22. The server of claim 21 further comprising a graphical traversal utility, the graphical traversal utility operable to:
traverse the defined relationships by matching identified relationships with each of the participants of that relationship; and
visualize, on a graphical display, a representation of each of the workspace artifacts for observation by a user.

23. A computer program product having a computer readable medium operable to store computer program logic embodied in computer program code encoded thereon, the computer program code receivable by a processor for executing computer program instructions for defining relationships between collaborative entities in a collaborative environment comprising:
computer program code for identifying an association between a plurality of workspace artifacts in a collaborative workspace, the association indicative of a commonality between the workspace artifacts, identifying further comprising identifying the commonality between workspace artifacts of different types;
computer program code for defining a relationship between the identified plurality of workspace artifacts, the workspace artifacts each having an entity type and a common relationship type corresponding to the identified association;
computer program code for capturing the relationship between the workspace artifacts, capturing denoting the workspace artifacts as participant entities in the defined relationship corresponding to the workspace; and
computer program code for storing, for each participant in the relationships, an entry in a relationship artifact table indicative of each artifact and relationship to which it belongs.

24. A computing device for performing fault tolerance in a collaboration environment comprising:
means for identifying an association between a plurality of workspace artifacts in a collaborative workspace, the association indicative of a commonality between the workspace artifacts, identifying further comprising identifying the commonality between workspace artifacts of different types;
means for defining a relationship between the identified plurality of workspace artifacts, the workspace artifacts each having an entity type and a common relationship type corresponding to the identified association;
means for capturing the relationship between the workspace artifacts, capturing denoting the workspace artifacts as participant entities in the defined relationship corresponding to the workspace; and
means for identifying dynamic relationships operable to identify relationship participants based on a predetermined selection criteria applicable to the plurality of artifacts, the predetermined selection criteria operable to conditionally identify entities for inclusion in a relationship.
